(19) United States
(12) Patent Application Publication
(10) Pub. No.: US 2017/0344527 A1
(43) Pub. Date: Nov. 30, 2017

(54) PROVIDING CHECKLIST TELEMETRY

(71) Applicant: MICROSOFT TECHNOLOGY LICENSING, LLC, Redmond, WA (US)

(72) Inventor: Martin Calsyn, Redmond, WA (US)

(73) Assignee: MICROSOFT TECHNOLOGY LICENSING, LLC, Redmond, WA (US)

(21) Appl. No.: 15/166,283

(22) Filed: May 27, 2016

(51) Int. Cl. G06F 17/24; G06F 3/0482; G06F 3/0484; H04L 29/08

(52) U.S. Cl. CPC G06F 17/24; H04L 67/22; G06F 3/0482; G06F 3/0484

(57) ABSTRACT

Techniques for providing checklist telemetry may be implemented. In examples, a notebook application may be configured to receive a checklist from an originator of a process now document. The checklist may include checklist items. The notebook application may also receive an update associated with a selected checklist item from a participant. The update may include a complete status, an incomplete status, a skipped status, or an abandon status. The notebook application may be further configured to identify information from the selected checklist item and aggregate contents of the checklist. The aggregated contents may include the update mid the information. The aggregated contents of the checklist may be provided to the originator.

### BACKGROUND

A notebook may include a collection of documents having a common theme for a user to keep track of and edit. For example, the notebook may be recorded that corresponds to a project. The notebook may have different tabs associated with different sections, and those sections may include, for example, a section for marketing research, a section for specification(s), a section for meeting notes and schedules, and a home page that generally describes the project. Each of the sections may include different pages, and each page may include one or more documents. The documents may include spreadsheets, word processing documents, emails, checklists, calendars, presentations, and any other document that may be part of the project,.

The checklist may be utilized for documenting steps in a business or a technical process. As the user progresses through the checklist, the user marks the steps as completed or incomplete. However, the user may discard or abandon the checklist, only to utilize a new checklist. As such, historical information regarding past successes or failures of each step in the checklist is difficult to document, often resulting in an inability to maintain an accuracy of the checklist. Verification of a past success or a past failure of an individual step in the checklist is difficult.

### SUMMARY

This summary is provided to introduce a selection of concepts in a simplified form that are further described below in the Detailed Description. This summary is not intended to exclusively identify key features or essential features of the claimed subject matter, nor is it intended as aid in determining the scope of claimed subject matter

Embodiments are directed to providing checklist telemetry. In examples, notebook application may be configured to receive a checklist from an originator of a process flow document. The checklist may include checklist items. The notebook application may also receive an update associated with a selected checklist item from a participant. The update may include a complete status, an incomplete status, or an abandon status. The notebook application may be further configured to identify information from the selected checklist item and aggregate contents of the checklist. The aggregated contents may include the update and the information. The aggregated contents of the checklist may be provided to the originator.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a conceptual diagram illustrating an example method to provide checklist telemetry in conjunction with a notebook application;

FIG. 2 is a display diagram illustrating a process to receive an update associated with a selected checklist item from a checklist in a process flow document;

FIG. 3 is a display diagram illustrating a process to identify information from a selected checklist item associated with a checklist in a process flow document;

FIG. 4 is a display diagram illustrating execution of a modification action on a checklist item in response to receiving aggregated contents of a checklist;

FIG. 5 is a networked environment, where a system according to embodiments may be implemented;

FIG. 6 is a block diagram of an example computing device, which may be used for providing checklist telemetry; and

FIG. 7 illustrates a logic flow diagram of a method to provide checklist telemetry in conjunction with a notebook application, according to embodiments.

### DETAILED DESCRIPTION

As briefly described above, embodiments are directed to providing checklist telemetry. In examples, a notebook application to create and process a notebook as described herein may be configured to receive a checklist from an originator of a process flow document. The checklist may include checklist items. The notebook application may also receive an update associated with a selected checklist item from a participant. The update may include a complete status, an incomplete status, or an abandon status. The notebook application may be further configured to identify information from the selected checklist item and aggregate contents of the checklist. The aggregated contents may include the update and the information. The aggregated contents of the checklist may be provided to the originator.

In some examples, the notebook application may be further configured to enable the participant to skip the selected checklist item. In response, the notebook application may then be further configured to label the update as haying the incomplete status. In other examples, the notebook application may be further configured to enable the originator to execute a modification action on a modification pane of the user interface. The modification action may include a modification to the information associated with the selected checklist item based on the incomplete status. The notebook application may then update the selected checklist item based on the modification and may then prompt the participant to respond to the selected checklist item with another update.

In further examples, the notebook application may be configured to enable the participant to provide feedback associated with the selected checklist item. The feedback may include audio feedback, textual feedback, and/or graphical feedback, among other forms of feedback. The notebook application may also be configured to enable the originator to perform one or more actions on the modification pane associated with the user interface. The one or more actions may include adding a new checklist item, modifying one of the checklist items, and/or deleting one of the checklist items, among others.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including band-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media,

Throughout this specification, the term “platform” may be a combination of software and hardware components for providing checklist telemetry, Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and one or more processors that includes a server, a desktop computer, a laptop computer, a tablet computer, a smart phone, a vehicle, mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. Actions or operations described herein may be executed on a single processor, on multiple processors (in a single machine or distributed over multiple machines), or on one or more cores of a multi-core processor. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer rummy, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input, An application programming interface (API) may be a set of routines, protocols, and tools for an application or service that allow the application or service to interact or communicate with one or more other applications and services managed by separate entities.

While example implementations are described using checklists, checklist items, and attributes associated with the checklist items herein, embodiments are not limited to checklist items. Providing checklist telemetry may be implemented in other environments, such as communications, instant messages, data sharing, application sharing, online conferencing, and similar communications, where checklist data and attributes associated with the checklist items may be exchanged.

The technical advantages of providing checklist telemetry may include, among others, an increased accuracy in responses to the checklist through documenting information, attributes, and updates associated with the items of the checklist. Further, by analyzing historical trends associated with the updates to a selected checklist item, past successes and failures of the selected checklist item can be identified, allowing an originator of the checklist to modify the selected checklist item and increase the success of the checklist item, as well as the entire checklist. Processing and network bandwidth may be reduced, as well as memory and processor burden, by eliminating a need to verify each checklist item individually.

Embodiments address a need that arises from very large scale of operations created by networked computing and cloud based services that cannot be managed by humans. The actions/operations described herein are not a mere use of a computer, but address results of a system that is a direct consequence of software used as a service such as data services offered in conjunction with providing checklist telemetry.

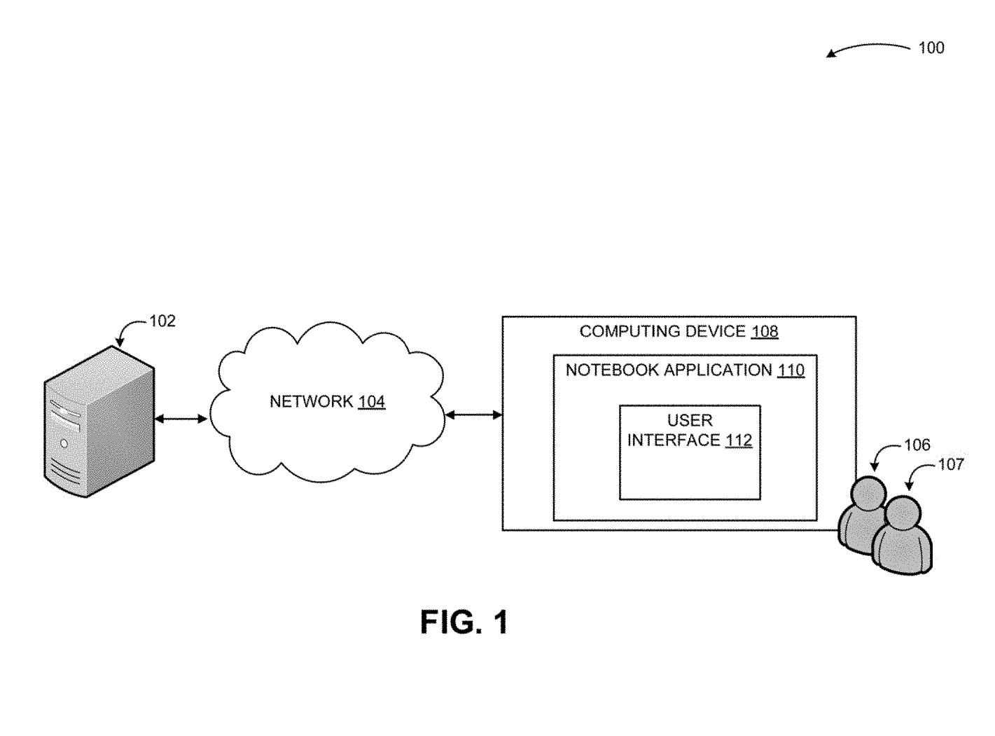

FIG. 1 includes a conceptual diagram illustrating an example method to provide checklist telemetry in conjunction with a notebook application.

As shown in a diagram 100, a computing device 108 may execute a notebook application 110. The computing device 108 may include a display device, such as a touch enabled display component, and a monitor, among others, to provide the notebook application 110 on a user interface 112 to a participant 106, The computing device 108 may include a desktop computer, a laptop computer, a tablet, a handheld device, a vehicle mount computer, an embedded computer system, a smart phone, and/or a wearable computer, among other similar computing devices, for example.

In some examples, the notebook, application 110 may be provided by a third party service (e.g., a data service), web applications, and/or a datacenter, among others. In other examples, the notebook application 110 may be coupled to one or more presence services over a network 104 to determine presence information for the participants associated with the notebook application 110. Example presence services may include a communication application, a social network, a professional network, and/or a presence module of the notebook application 110, among other examples. Local access to the notebook application 110 may be provided by locally installed rich clients (e.g., a local version of the notebook application 110) or generic applications, such as a browser on the computing device 108.

In other examples, the notebook application 110 may be executed on a server 102 (e.g., a data server). The server 102 may include a web server or a document server, among others. The computing device 108 (e.g., a local system) may communicate with the server 102 (e.g., a remote system) through the network 104. The network 104 may provide wired or wireless communications between nodes, such as the computing device 108 or the server 102.

In further examples, the notebook application 110 may provide a notebook on the user interface 112 to the participant 106. The notebook may include a collection of documents sharing a common theme for the participant 106 or an originator 107 to keep track of and edit. For example, the notebook may be recorded that corresponds to a project. The notebook may have different tabs associated with different sections, and those sections may include, for example, a section for marketing research, a section for specification(s), a section for meeting notes and schedules, and a home page that generally describes the project. Each of tile sections may include different pages, and each page may include one or more documents. The one or more documents may include spreadsheets, word processing documents, checklists, mails, calendars, presentations, and any other document that may be, part of the project. Thus, the notebook may represent a knowledge base that includes a wide variety of different documents. In a collaborative environment, the notebook application 110 may enable multiple participants to access, view, and edit. any of the sections, pages, and/or documents within the notebook.

The notebook application 110 may track one or more interactions of the participant 106 and/or the originator 107 in conjunction with a location within the notebook application 110 to record history information associated with the participant 106 and/or the originator 107. The history information recorded may include a frequency of the interactions, an occurrence of the interactions, and/or a type of the interactions. The types of interactions may include editing, viewing, and/or communicating within a document, page, section, and/or notebook of, the notebook application 110. The history information may be stored at a data store. The data store may be within the notebook application 110 or a separate data store. The history information may be retrieved from the data store in response to a request from the notebook application 110.

In examples, the notebook application 110 may be configured to receive a checklist from the originator 107 associated with the notebook or a process flow document. The process flow document may be designed to “reflow content” depending on window size, device resolution, and other environment variables of the computing device 108. In addition, the process flow document may include built in features, such as search, viewing modes that optimize readability, and an ability to change the size and appearance of fonts.

The checklist may include checklist items. The checklist may be utilized for documenting steps, in a business or a technical process. The checklist may be a type of informational aid used to enhance consistency and completeness in carrying out a task. Essentially, the checklist may be used in any stepwise business process. In examples, the checklist may include a to do list or a schedule. Examples of the checklist may include a pre-flight checklist aid in aviation safety, a surgical safety checklist, a quality assurance checklist used in software engineering to check for process compliance and code standardization, an open-source litigation checklist, an ornithological checklist, any recipe to make a food item, an instruction manual to build a piece of furniture, an instruction manual to repair a jam in a copier, and an instruction manual to change a tire on a car, among others. Overall, the checklist may include a listing of steps where the participant 106 follows instructions to carry out a task, while interacting with a system.

The notebook application 110 may also be configured to receive an update associated with a selected checklist item from the participant 106 The update may also include one of a complete status, an incomplete status, or an abandon status. The notebook application 110 may be further configured to identify information from the selected checklist item and may aggregate contents of the checklist. The process of identifying the information and aggregating the contents of the checklist may be identified as telemetry. The aggregated contents may include the update and/or the information, among others. The notebook application 110 may be further configured to provide the aggregated contents of the checklist to the originator 107.

While the example system in FIG. 1 has been described with specific components including the computing device 108, the notebook application 110, the originator 107, the participant 106, and the server 102, embodiments are not limited to these components or system configurations and can be implemented with other system configuration employing fewer or additional components.

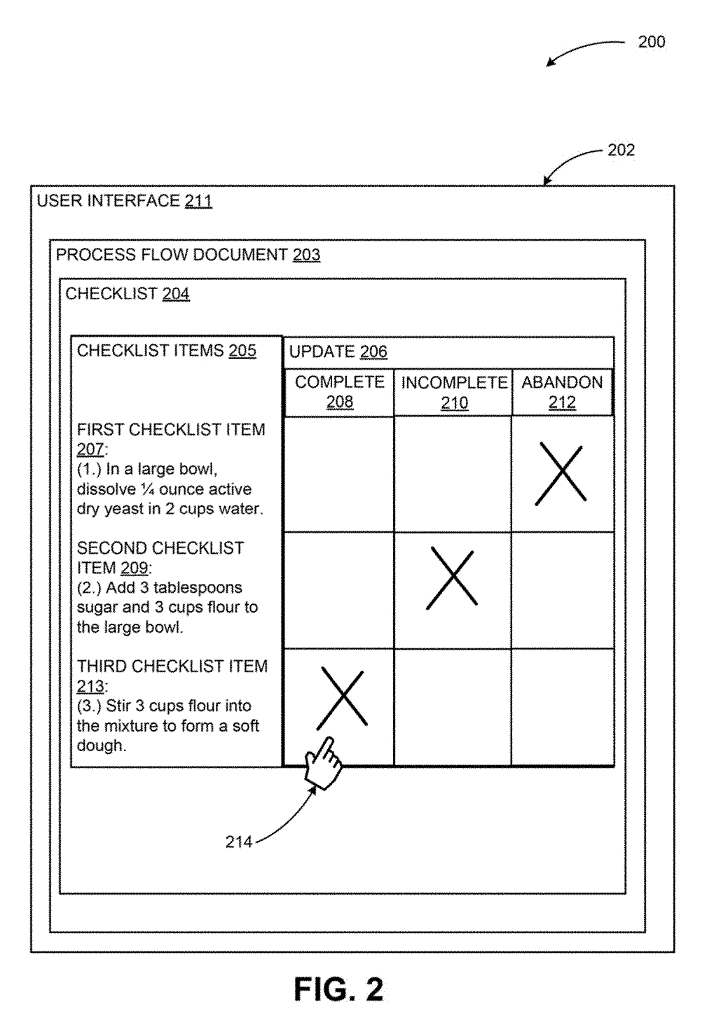

FIG. 2 is a display diagram illustrating a process to receive an update associated with a selected checklist item from a checklist in a process flow document, according to at least some embodiments disclosed herein.

As shown in a diagram 200, a computing device 202 may execute a notebook application and may cause a user interface 211 associated with the notebook application to be presented. The notebook application may receive a checklist 204 from an originator of a process flow document 203. In an example, the checklist 204 may include a recipe to make a loaf of bread. The checklist 204 may include checklist items 205 (e.g., a first checklist item 207, a second checklist item 209, and a third checklist item 213).

The checklist items 205 (e.g., the first checklist item 207, the second checklist item 209, and the third checklist item 213) may include steps in the recipe. For example, the first checklist item 207 may include a step to, “in a large howl, dissolve ¼ ounce active dry yeast in two cups of water.” The second checklist item 209 may include a step to, “add three tablespoons of sugar and three cups of flow to the large bowl.” The third checklist item 213 may include a step to, “stir three cups of flour into the mixture to form a soft dough.”

The notebook application may enable the participant to interact with a selected checklist item (e.g., the first checklist item 207, the second checklist item 209, or the third checklist item 213) and contents of the notebook application through the user interface 211 associated with the notebook application. The participant may interact with the user interface 211 by executing an action 214 on an update 206 of the selected checklist item (e.g., the first checklist item 207, the second checklist item 209, or the third checklist item 213) or hovering over the selected checklist item (e.g., the first checklist item 207, the second checklist item 209, or the third checklist item 213) on the user interface 211. The action 214 may include a swipe action, a mouse input, a pen input, and/or a keyboard input executed on a graphical element associated with the selected checklist item (e.g., the first checklist item 207, the second checklist item 209, or the third checklist item 213) on the user interface 211. In outer examples, the action 214 may be executed on the selected checklist item (e.g., the first checklist item 207, the second checklist item 209, or the third checklist item 213) on a modification pane associated with the user interface 211.

By executing the action 214, the participant may be enabled to view additional information and/or attributes associated with the selected checklist item (e.g., the first checklist item 207, the second checklist item 209, or the third checklist item 213). The information may include metadata associated with the checklist items 205. Furthermore, the participant may be enabled to replay and/or review edits made to the process flow document 203 within the notebook application. For example, the participant may view additions, deletions, modifications, and/or comments made to the process flow document 203 over time and to view bow the process flow document 203 has evolved or changed.

The notebook application may also receive, in response to the action 214 executed on the user interface 211, the update 206 associated with the selected checklist item (e.g., the first checklist item 207, the second checklist item 209, or the third checklist item 213) from the participant The update 206 may include a complete status 208, an incomplete status 210, or an abandon status 212.

In an example, the complete status 208 may indicate that the selected checklist item (e.g., the third checklist item 213) has been finished. The abandon status 212 may indicate that the selected checklist item (e.g., the first checklist item 207) has been skipped or the checklist 204 has been abandoned. In this scenario, a first participant may have started the checklist and abandoned the first checklist item 207 during a first time period. A second participant may have started the checklist 204 during a second time period at the third checklist item 213, erroneously skipping the first checklist item 207 and the second checklist item 209. As the notebook application aggregates the update 206 of each checklist item 205, the second participant who begins the checklist 204 during the second time period may view and remedy errors that the first participant may have made during the first time period.

In some examples, the notebook application may be configured to enable the participant to skip the selected checklist item (e.g., the second checklist item 209). The notebook application may then label the update 206 as having the incomplete status 210.

In other examples, the selection of the update 206 may be automated through use of an application program interface (API). The API is a set of routines, protocols, and tools for the notebook application that allow the notebook application to interact or communicate with one or more other applications and/or services managed by separate entities. For example, the notebook application may automatically determine the first checklist item 207 as being complete and may mark the first checklist item as having the complete status 208.

In other examples, the notebook application may identify a credential associated with the participant: The credential may be compared a predefined rule. In some examples, the predefined rule may be system-dependent, may be participant-defined, or may be originator-defined. The notebook application may detect a match between the credential and the predefined rule and may identify the participant as the originator. In other examples, if the notebook application detects a mismatch between the credential and the predefined rule, the notebook application may fail to identify the participant as the originator. In this case, the notebook application may provide an alert on the user interface to the originator. The alert may include an audio alert, a visual alert, a tactile alert, and/or a textual alert, among others.

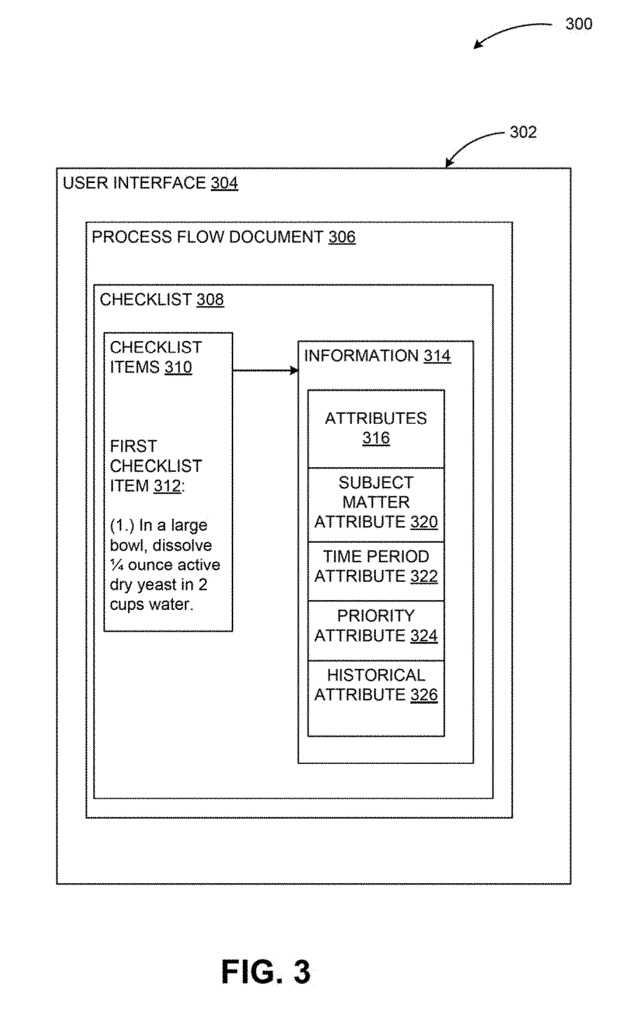

FIG. 3 is a display diagram illustrating a process to identify information from a selected checklist item associated with a checklist in a process flow document.

As shown in a diagram 300, a computing device 302 may execute a notebook application. The computing device 302 may include a display device, such as a touch enabled display component, and a monitor, among others, to provide the notebook application on a user interface 304 to a participant and/or an originator, The notebook application may receive a checklist 308 from an originator of a process flow document 306. The checklist 308 may include checklist items 310.

The notebook application may receive an update associated with a selected checklist item (e.g., a first checklist item 312) from a participant. The update may include a complete status, an incomplete status, or an abandon status. The notebook application may additionally be configured to identify information 314 from the selected checklist item (e.g., the first checklist item 312).

The information may include statistical information associated with the selected checklist item (e.g., the first checklist item 312). The statistical information may include a completion time associated with completion of the selected checklist item, edits made to the selected checklist item over a specified time period, feedback given by the participant and associated with the selected checklist item, a failure rate associated with the selected checklist item over the specified time period, and/or a success rate of the selected checklist item over the specified time period, among other examples.

In some examples, the notebook application may be further configured to analyze the information 314 to identify attributes 316 associated with the information 314. The attributes 316 may include a subject matter attribute 320 associated with the selected checklist item (e.g., the first checklist item 312). The subject matter attribute 320 may include words, phrases, or sentences in the selected checklist item (e.g., the first checklist item 312). In other examples, the subject matter attribute may include contextually-related words or phrases in the selected checklist item (e.g., the first checklist item 312). In other examples, the attributes 316 may also include a time period attribute 322 by which the selected checklist item (e.g., the first checklist item 312) was completed. The time period attribute 322 may be measured in seconds, minutes, hours, or days, etc.

In other examples, the attributes 316 may include a priority attribute 324 associated with the selected checklist item (e.g., the first checklist item 312). The priority attribute 324 may be defined by the originator of the process flow document 306. The attributes 316 may further include a historical attribute 326 associated with a completion of the selected checklist item (e.g., the first checklist item 312) and indicate by the complete status, among others.

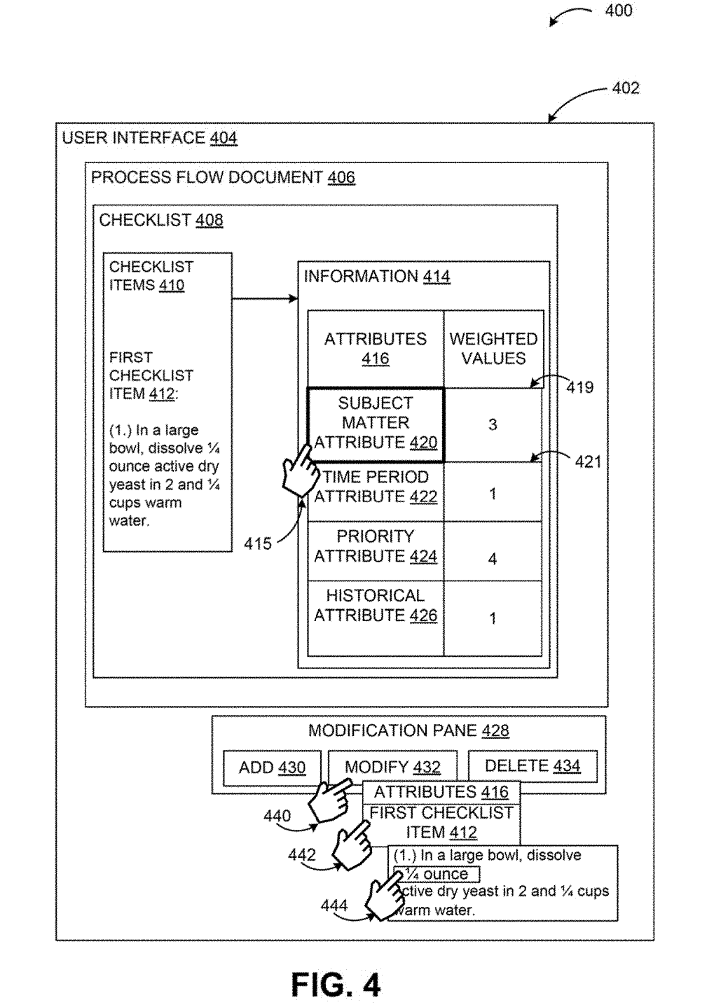

FIG. 4 is a display diagram illustrating execution of a modification action on a checklist item in response to receiving aggregated contents of a checklist.

As shown in a diagram 400, a computing device 402 may execute a notebook application. The computing device 402 may include a display device, such as a touch enabled display component, and a monitor, among others, to provide the notebook application on a user interface 404 to a participant. The notebook application may receive a checklist 408 from an originator of a process flow document 406. The checklist 408 may include checklist items 410.

The notebook application may be configured to receive an update associated with a selected checklist item (e.g., a first checklist item 412) from the participant. The update may include a complete status, an incomplete status, or an abandon status. The notebook application may additionally be configured to identify information 414 from the selected checklist item (e.g., the first checklist item 412).

In some examples, the notebook application may be further configured to analyze the information 414 to identify attributes 416 associated with the information 414. As explained in FIG. 3, the attributes 416 may include a historical attribute 426 associated with a completion of the selected checklist item (e.g., the first checklist item 412) and indicated by the complete status, a priority attribute 424 associated with the selected checklist item (e.g., the first checklist item 412), a subject matter attribute 420 associated with the selected checklist item (e.g., the first checklist item 412), and/or a time period attribute 422 by which the selected checklist item (e.g., the first checklist item 412) was completed, among others.

In some examples, the notebook application may identify the update as one of the incomplete status or the abandon status. The notebook application may then assign a weighted value 419 to the subject matter attribute 420 and may assign a weighted value 421 to the time period attribute 422, In a first example, the notebook application may detect the weighted value 419 as being a weighted value of three and may detect the weighted value 421 as being a weighted value of one. The notebook application may then compare the weighted value 419 (e.g., the weighted value of three) associated with the subject matter attribute 420 to the weighted value 421 (e g., the weighted value of one) associated with the time period attribute 422. The notebook application may then detect the weighted value 419 as being greater than the weighted value 421. The notebook application may then enable the originator to execute a modification action 440 on a modification pane 428 of the user interface 404. The modification action may include a modification to the time period attribute 422 associated with the weighted value 421. The notebook application may then update the selected checklist item (e.g., the first checklist item 412) based on the modification and prompt the participant to respond to the modified checklist item with another update.

in another example, the notebook application may identify the update as one of the incomplete status or the abandon status. The notebook application may then assign a weighted value 419 to the subject matter attribute 420 and may assign a weighted value 421 to the time period attribute 422. The notebook application may detect the weighted value 419 as being a wieghted value of two and may detect the weighted value 421 as being a weighted value of four. The notebook application may then compare the weighted value 419 (e.g., the weighted value of two) associated with the subject matter attribute 420 to the weighted value 421 (e.g., the weighted value of four) associated with the time period attribute 422. The notebook application may then detect the weighted value 419 as being less than the weighted value 421. The notebook application may then enable the originator to execute the modification action 440 on a modification pane 428 of the user interface 404. The modification action may include a modification to the subject matter attribute 420 associated with the weighted value 419. The notebook application may then update the selected checklist item (e.g., the first checklist item 412) based on the modification and prompt the participant to respond to the modified checklist item with another update.

In additional examples, in response to the notebook application identifying the update as one of the incomplete status or the abandon status, the notebook application may detect weighted values associated with two or more of the attributes 416 (e.g., the subject matter attribute 420 the time period attribute 422, the priority attribute 424, and the historical attribute 426) and may perform similar comparisons and analyses. The notebook application may perform these analyses to identify the lowest weighted value(s). The originator may be enabled to execute the modification action 440 on the attributes 416 associated with the lowest weighted value(s) in an attempt to increase the weighted value score and modify the update from the incomplete status or the abandon status to the complete status during another time period. The modification of the update from the incomplete status or the abandon status to the complete status during the other time period results in a successful completion of the selected checklist item.

In some examples, the notebook application may be further configured to enable the participant to provide feedback associated with the selected checklist item the first checklist item 412). The feedback may include audio feedback, textual feedback, and/or graphical feedback, among other forms of feedback, The notebook application may enable the originator to perform one or more actions on the modification pane 428 on the user interface 404. The one or more actions, may include an addition 430 of a new checklist item, a modification 432 of one of the checklist items 410, and/or a deletion 434 of one of the checklist items 410. The notebook application does not remove past telemetry with the addition 430 of the new checklist item. An example of the modification 432 of the one or more checklist items 410 may include an action 442 executed on the first checklist item 412 to modify a selected word or a selected phrase of the first checklist item 412 The modification of the selected word or the selected phrase may include performing another modification action 444 on “¼ ounce” to replace “¼ ounce” with “⅓ ounce.”

The notebook application may also be configured to identify the information 414 from the selected checklist item (e.g., the first checklist item 412), aggregate contents (e.g., the update and/or the information 414) of the checklist 408, and provide the aggregated contents of the checklist 408 to the originator. In some examples, the notebook application may be further configured to perform an analysis on the aggregated contents.

In some examples, the analysis may be performed by using one or more machine learning techniques and/or machine learning algorithms. The machine learning techniques may include pattern recognition and computational learning theory, among others. The machine learning algorithms may learn and make predictions. Common machine learning algorithms may include supervised learning algorithms, unsupervised learning algorithms, and reinforcement learning algorithms. Some of the machine learning algorithms may include linear regression algorithms, logistic regression algorithms, decision tree algorithms, support vector machine (SVM) algorithms, Naive Bayes algorithms, a K-nearest neighbors (KNN) algorithm, a K-means algorithm, a random forest algorithm, dimensionality reduction algorithms, and a Gradient Boost & Adaboost algorithm, among others.

In additional examples, the notebook application may be further configured to identify the selected checklist item (e.g., the first checklist item 412) as failing to exceed a threshold. The threshold may include a timing threshold or an urgency threshold. The threshold may be system-dependent or may be modified by the participant or the originator. The notebook application may be further configured to provide an alert to the originator to prompt the originator to modify the information 414 associated with the selected checklist item (e.g., the first checklist item 412). In response to receiving the modification to the information 414 the notebook application may be further configured to update the selected checklist item (e.g., the first checklist item 412) based on the modification and prompt the participant to respond to the selected checklist item (e.g., the first checklist item 412) with another update.

In further examples, the notebook application may be further configured to perform an analysis on the aggregated contents and identify the selected checklist item (e.g., the first checklist item 412) as exceeding the threshold. The notebook application may be further configured to enable the originator to perform one or more actions on the modification pane 428. The actions may include modifying a subset of the information 414 associated with the selected checklist item (e.g., the first checklist item 412), deleting a subset of the information 414 associated with the selected checklist item (e.g., the first checklist item 412), and/or adding a subset of the information 414 to the selected checklist item (e.g., the first checklist item 412).

In additional examples, the notebook application may be further configured to perform an analysis on the aggregated contents of the checklist to determine a historical trend associated with each of the complete status, the abandon status, and the incomplete status. The historical trend may identify the checklist items 410 successful over a time period (given by the complete status) and the checklist items 410 unsuccessful over the time period (given by the abandon status or the incomplete status). Utilizing this information, the originator may modify specific checklist items 410 and/or information associated with the checklist items 410 to try to identify a point of failure, to make the checklist 408 more successful during a subsequent time period,

The examples in FIG. 1 through 4 have been described with specific systems including specific user interface elements, configurations, and presentations. Embodiments are not limited to systems according to these example configurations. Providing checklist telemetry in a notebook application may be implemented in configurations using other types of systems including specific user interface elements, configurations, and presentations in a manner using the principles described herein.

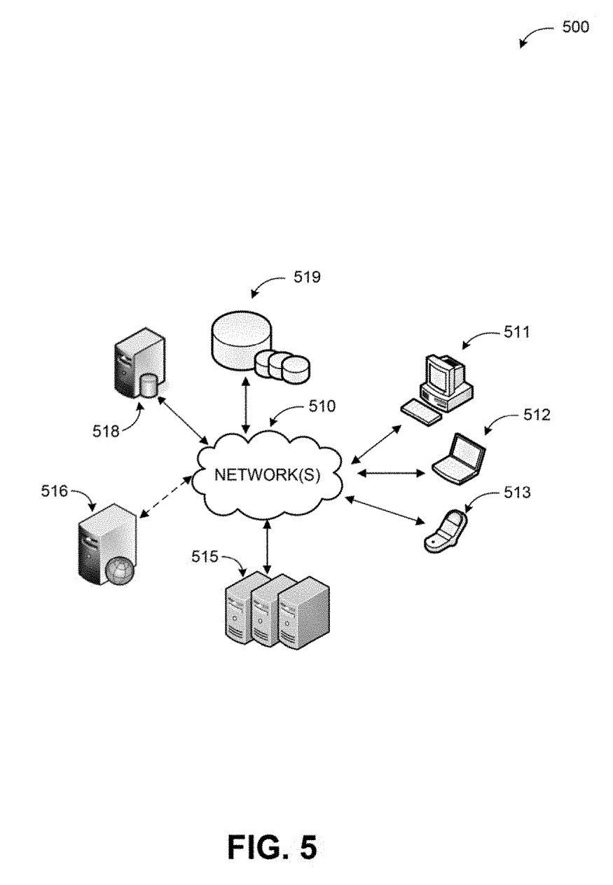

FIG. 5 is a networked environment, where a system according to embodiments may be implemented.

A system to provide checklist telemetry in a notebook application may be implemented via software executed over one or more servers 14 such as a hosted service. The platform may communicate with client applications on individual computing devices such as a smart phone 513, a tablet computer 515, a laptop computer 512, or desktop computer 511 (‘client devices’) through network(s) 510.

Client applications executed on any of the client devices 511-513 may facilitate communications via application(s) executed by servers 514, or on individual server 516. A notebook application may be executed on one of the servers. The notebook application may be configured to receive a checklist from an originator of a process flow document. The checklist may include checklist items. The notebook application may be further configured to receive an update associated with a selected checklist item from a participant. The update may include a complete status, an incomplete status, or an abandon status. The notebook application may be further configured to identify information from the selected checklist item and aggregate contents of the checklist. The aggregated contents may include the update and the information. The notebook application may be further configured to provide the aggregated contents of the checklist to the originator.

In examples, the notebook application may also retrieve checklist data, the information, and attributes associated with the checklist items from data store(s) 519 directly Or through database server 518, and provide requested services (e.g., document editing) to the user(s) (e.g., the originator and the participants) through client devices 511-513. The attributes may include a historical attribute associated with a completion of the selected checklist item and indicated by the complete status, a priority attribute associated with the selected checklist item, a subject matter attribute associated with the selected checklist item, and/or a time period attribute by which the selected checklist item was completed, among other examples.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include, short range wireless networks such as Bluetooth or similar ones. Network(s) 510 provide communication between the nodes described herein. By way of example, and not limitation, networks) 510 may include wireless media such as acoustic. RF, infrared and other wireless media.

Many other configurations of computing devices, applications, data sources, and data distribution systems may be employed to implement a platform providing checklist telemetry in conjunction with a notebook application. Furthermore, the networked environments discussed in FIG. 5 are for illustration purposes only. Embodiments are not limited to the example applications, modules, or processes.

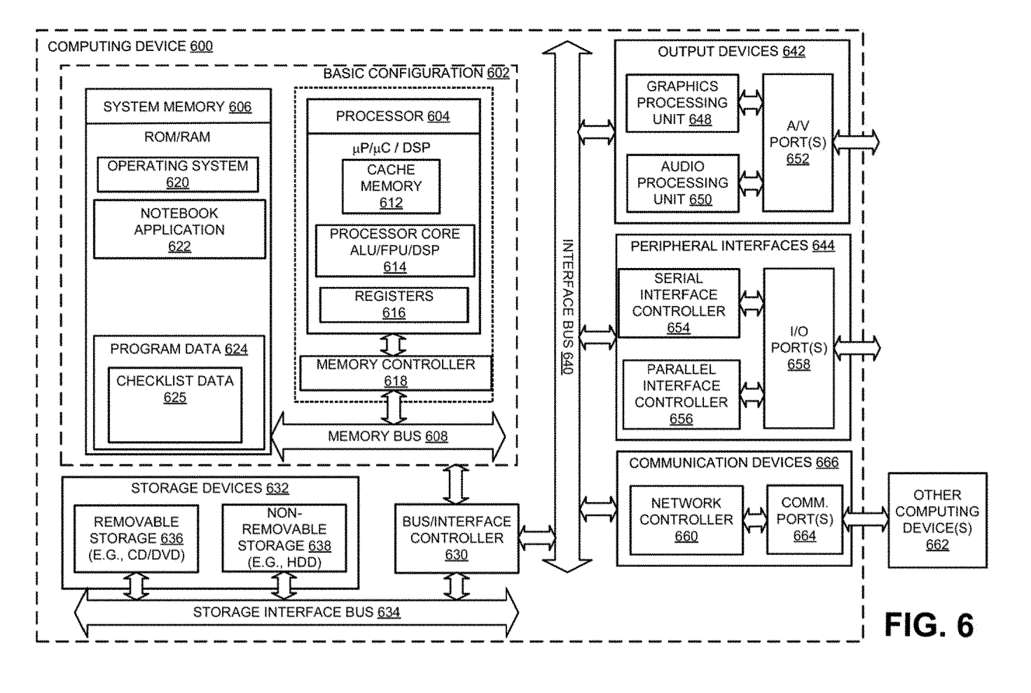

FIG. 6 is a block diagram of an example computing device, which may be used for providing checklist telemetry, according, to embodiments.

For example, a computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The example basic configuration 602 may be illustrated in FIG. 5 by those components within the inner dashed line.

Depending on the desired configuration, the processor 704 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The one or more processor cores 614 may (each) include an arithmetic logic unit (ALU), a floating point unit (FPU), a digital signal processing core (DSP Core), or any combination thereof. An example memory controller 618 may also be used with the processor 604, or in some implementations, the example memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a notebook application 622, and a program data 624. The notebook application 622 may be configured to receive a checklist from an originator of a process flow document. The checklist may include checklist items. The notebook application 622 may also be configured to receive an update associated with a selected checklist item from a participant. The update may include a complete status, an incomplete status, or an abandon status. The notebook application 622 may be thither configured to identify information from the selected checklist item and aggregate contents of the checklist. The aggregated contents may include the update and/or the information. The notebook application 622 may then be further configured 10 provide the aggregated contents of the checklist to the originator. The program data 624 may include checklist data 625 and other information, as described herein. The checklist data 625 may include the information. The information may include attributes, such as, a historical attribute associated with a completion of the selected checklist item and indicated by the complete status, a priority attribute associated with the selected checklist item, a subject matter attribute associated with the selected checklist item, and/or a time period attribute by which the selected checklist item was completed, among others.

The computing device 600 may have additional features or functionality, and additional interfaces to facilitate communications between the example basic configuration 602 and any desired devices and interfaces. For example, a bus/interface controller 630 may be used to facilitate communications between the example basic configuration 602 and one or more data storage devices 632 via a storage interface bus 634, The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology. CD-ROM, digital versatile disks (DVDs), solid state drives, or other optical storage, magnetic cassettes, magnetic tape, magnetic disk storage or other magnetic storage devices, or any other medium which may be used to, store the desired information and which may be accessed by the computing device 600. Any such computer storage media may be part of the computing device 600.

The computing device 600 may also include an interlace bus 640 for facilitating communication from various interface devices (for example, one or more output devices 642, one or more peripheral interfaces 644, and one or more communication devices 646) to the example basic configuration 602 via the bus/interface controller 630. Some of the one or more output devices 642 include a graphics processing unit 648 and an audio processing unit 650, which may be configured to communicate to various external devices such as a display or speakers via one or more A/V ports 652. The one or more peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more 170 ports 658. An example communication device 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods for providing checklist telemetry. These methods can be implemented in any number of ways, including the structures described herein. One such way may be b machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria hat may be machine automated.

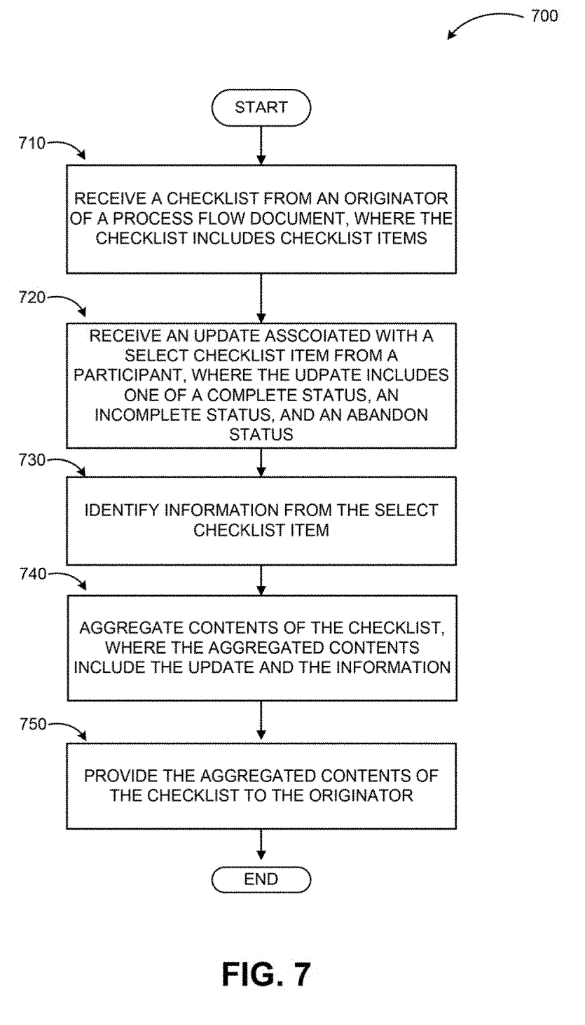

FIG. 7 illustrates a logic flow diagram of a method to provide checklist telemetry in conjunction with a notebook application, according to embodiments.

In some examples, a process 700 may be implemented on a server or other system. In other examples, the process 700 may be in on a computing device, such as the computing device 600, or with another system. The computing device 600 may execute a notebook application and may cause a user interface associated with the notebook application to be presented.

The process 700 begins with an operation 710, where the notebook application may receive a checklist from an originator of a process flow document. The checklist may include checklist items. At an operation 720, the notebook application may receive an update associated with a selected checklist item from a participant. The update may include complete status, an incomplete status, or an abandon status.

In some examples, the notebook application may enable the participant to skip the selected checklist item. In response, the notebook application may label the update as having the incomplete status. The notebook application may be further configured to enable the originator to execute a modification action on a modification pane of the user interface. The modification action may include a modification to the information associated with the selected checklist item based on the incomplete status. The notebook application may additionally be configured to update the selected checklist item based on the modification and prompt the participant to respond to the selected checklist item with another update.

In other examples, the notebook application may be further configured to enable the participant to provide feedback associated with the selected checklist item. The feedback may include audio feedback, textual feedback, and/or graphical feedback. The notebook application may additionally be configured to enable the originator to perform one or more actions. The one or more actions include adding a new checklist item, modifying one of the checklist items, and/or deleting one of the checklist items.

At an operation 730, the notebook application may identify information from the selected checklist item. The information may be analyzed to identify a historical attribute associated with a completion of the selected checklist item and indicated by the complete status, a priority attribute associated with the selected checklist item, a subject matter attribute associated with the selected checklist item, and/or a time period attribute by which the selected checklist item was completed.

At an operation 740, the notebook application may aggregate contents of the checklist. The aggregated contents may include the update and/or the information, among others. At an operation 750, the notebook application may provide the aggregated contents of the checklist to the originator.

In some examples, the notebook application may be further configured to perform an analysis on the aggregated contents and identify the selected checklist item as failing to exceed a threshold. The threshold may include a timing threshold or an urgency threshold. The notebook application may also be configured to provide an alert to the originator to prompt the originator to modify the information associated with the selected checklist item. In response to receiving the modification to the information, the notebook application may be configured to update the selected checklist item based an the modification and may prompt the participant to respond to the selected checklist item with another update.

The operations included in process 700 are for illustration purposes. Providing checklist telemetry may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some embodiments, computing devices for providing checklist telemetry may be described. An example computing device may include a memory configured to store instructions and a processor coupled to the memory. The processor may execute a notebook application and may cause a User interface associated with the notebook application to be presented. The notebook application may be configured to receive a checklist from an originator of a process flow document. The checklist may include checklist items. The notebook application may be further configured to receive an update associated with a selected checklist item from a participant. The update may include a complete status, an incomplete status, or an abandon status. The notebook application may be further configured to identify information from the selected. Checklist item, aggregate contents of the checklist, and provide the aggregated contents of the checklist to the originator. The aggregated contents may include the update and the information.

According to other embodiments, the notebook application may be further configured to analyze the information to identify a historical attribute associated with a completion of the selected checklist item and indicated by the complete status, a priority attribute associated with the selected checklist item, a subject matter attribute associated with the selected checklist item, and/or a time period attribute by which the selected checklist item was completed.

In other examples, the notebook application may be further configured to assign a first weighted value to the subject matter attribute and assign a second weighted value to the time period attribute, The notebook application may be further configured to compare the first weighted value to the second weighted value some examples, the notebook application may be further configured to identify the update as one of the incomplete status or the abandon status, detect the first weighted value as being greater than the second weighted value, and enable the originator to execute a modification action on a modification pane of the user interface. The modification action may include a modification to the time period attribute associated with the second weighted value. The notebook application may be further configured to update the selected checklist item based on the modification and prompt the participant to respond to the modified checklist item with another update.

In other examples, the notebook application may be further configured to assign a first weighted value to the subject matter attribute and assign a second weighted value to the time period attribute. The notebook application may be further configured to compare the first weighted value to the second weighted value in other examples, the notebook application may be further configured to identify the update s one o the incomplete status or the abandon status, detect the second weighted value as being greater than the first weighted value, and enable the originator to execute a modification action on a modification pane of the user interface. The modification action may include a modification to the subject matter attribute associated with the first weighted value. The notebook application may be further configured to update the selected checklist item based on the modification and prompt the participant respond to the selected checklist item with another update.

According to further embodiments, the notebook application may be further configured to assign a first weighted value to the historical attribute and assign a second weighted value to the priority attribute. The notebook application may compare the first weighted value to the second weighted value. The notebook application may be further configured to identify the update as one f the incomplete status and the abandon status, detect the first weighted value as being greater than the second weighted value, and enable the originator to execute a modification action on at modification pane of the user interface. The modification action may include a modification to the priority attribute associated with the second Weighted value. The notebook application may be further configured to update the selected checklist item based on the modification and prompt the participant to respond to the selected checklist item with another update.

According to some embodiments the notebook application may be further configured to identify the update as one of the incomplete status or the abandon status, detect the second weighted value as being greater than the first weighted value, and enable the originator to execute a modification action on a modification pane of the user interface. The modification action may include modification to the historical attribute associated with the first weighted value. The notebook application may be further configured to update the selected checklist item based on the modification and prompt the participant to respond to the selected checklist item with another update.

According to further embodiments, the notebook application may be further configured to, in response to enabling the participant to skip the selected checklist item, label the update as having one of the incomplete status or a skipped status. The notebook application may be further configured to enable the originator to execute a modification action on a modification pane of the user interface. The modification action may include a modification to the information associated with the selected checklist item based on the incomplete status. The notebook application may be further configured to update the selected checklist item based on the modification and prompt the participant to respond to the selected checklist item with another update.

According to some embodiments, a means for providing checklist telemetry may be described, which may include a means for receiving a checklist from an originator of a process flow document. The checklist may include checklist items. The means for providing checklist telemetry may also include a means for receiving an update associated with a selected checklist item from a participant, The update may also include a complete status or an abandon status. In response to enabling the participant to skip the selected checklist item, the means for providing checklist telemetry may also include a means for labeling the update as having one of an incomplete status or a skipped status. The means for providing checklist telemetry may further include a means for identifying information from the selected checklist item, a means for aggregating contents of the checklist, and a means for providing the aggregated contents of the checklist to the originator. The aggregated contents may include the update and the information.

According to further embodiments, methods executed an computing devices for providing checklist telemetry may be described. An example method may be executed on a computing device to provide checklist telemetry. The example method may include receiving a checklist from an originator of a process flow document. The checklist may include checklist items. The example method may also include receiving an update associated with a selected checklist item from a participant. The update may include a complete status or an abandon status. The example method may also include, in response to enabling the participant to skip the selected checklist item, labeling the update as having one of an incomplete status and a skipped status. The example method may further include identifying, information from the selected checklist item, aggregating contents of the checklist, and providing the aggregated contents of the checklist to the originator. The aggregated contents may include the update and the information.

According to some embodiments, the example method may further include enabling the participant to provide feedback associated with the selected checklist item. The feedback may include audio feedback, textual feedback, and/or graphical feedback. The example method may further include enabling the originator to perform actions that include: adding a new checklist item, modifying one of the checklist items, and/or deleting one of the checklist items.

According to some embodiments, the example method may further include performing an analysis on the aggregated contents, identifying the selected checklist item as failing to exceed a threshold, and providing an alert to the originator to prompt the originator to modify the information associated with the selected checklist item. The example method may further include, in response to receiving the modification to the information, updating the selected checklist item based on the modification and prompting the participant to respond to the selected checklist item with another update. The threshold may include a timing threshold and/or an urgency threshold, among other examples.

According to other embodiments, the example method may further include performing an analysis on the aggregated contents and identifying the selected checklist item as exceeding a threshold. The threshold may include a timing threshold and/or an urgency threshold. The example method may further include enabling the originator to perform one more actions that include: modifying a subset of the information associated with the selected checklist item, deleting a subset of the information associated with the selected checklist item, and/or adding a subset of the information to the selected checklist item. The example method may further include performing an analysis on the aggregated contents to determine a historical trend associated with each of the complete status, the abandon status, the skipped status and the incomplete status.

According to further embodiments, computer-readable storage devices with instructions stored thereon for providing checklist telemetry may be described. An example computer-readable storage device may include instructions, such as, receiving a checklist from an originator of a process flow document. The checklist may include checklist items. The instructions may further include receiving an update associated with a selected checklist item from a participant. The update may include a complete status or an abandon status. The instructions may further include, in response to enabling the participant to skip the selected checklist item, labeling the update as having one of an incomplete status and a skipped status. The instructions may further include identifying information from the selected checklist item, aggregating contents of the checklist, and providing the aggregated contents of the checklist to the originator. The aggregated contents include the update and the information.

According to some embodiments, the instructions may further include performing an analysis on the aggregated contents and identifying the selected checklist item as failing to exceed a threshold. The threshold may include one of timing threshold and an urgency threshold. The instructions may further include providing an alert to the originator to prompt the originator to modify the information associated with the selected checklist item. The instructions may further include, in response to receiving the modification to the information, updating the selected checklist item based on the modification. The instructions may further include prompting the participant to respond to the selected checklist item with another update.

According to sonic embodiments, the instructions may further include analyzing information to identify a historical attribute associated with a completion of the selected checklist item and indicated by the complete status, a priority attribute associated with the selected checklist item, a subject matter attribute associated with the selected checklist Item, and/or a time period attribute by which the selected checklist item was completed. The instructions may further include assigning a first weighted value to the subject matter attribute and assigning a second weighted value to the time period attribute. The instructions may further include comparing the first weighted value to the second weighted value. The instructions may further include identifying the update as one of the incomplete status and the abandon status, detecting the first weighted value as being greater than the second weighted value, enabling the originator to modify the time period attribute associated with the second weighted value, updating the selected checklist item based on the modification, and prompting the participant to respond to the modified checklist item with another update.

The above specification, examples and data provide a complete description of, the manufacture and use of the composition of the embodiments, Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. A computing device configured to provide checklist telemetry, the computing device comprising:
a memory configured to store instructions; and
a processor coupled to the memory, the processor executing a notebook application and causing a user interface associated with the notebook application to be presented, wherein the notebook application is configured to:
receive a checklist from an originator of a process flow document, wherein the checklist includes checklist items;
receive an update associated with a selected checklist item from a participant, wherein the update includes one of a complete status, an incomplete status, and an abandon status;
identify information from the selected checklist item;
aggregate contents of the checklist, wherein the aggregated contents include the update and the information; and
provide the aggregated contents of the checklist to the originator.

2. The computing device of claim 1, wherein the notebook application is further configured to:
analyze the information to identify one or more of: a historical attribute associated with a completion of the selected checklist item and indicated by the complete status, a priority attribute associated with the selected checklist item, a subject matter attribute associated with the selected checklist item, and a time period attribute by which the selected checklist item was completed.

3. The computing device of claim 2, wherein the notebook application is further configured to:
assign a first weighted value to the subject matter attribute and assign a second weighted value to the time period attribute; and
compare the first weighted value to the second weighted value.

4. The computing device of claim 3, wherein the notebook application is further configured to:
identify the update as one of the incomplete status and the abandon status;
detect the first weighted value as being greater than the second weighted value;
enable the originator to execute a modification action on a modification pane of the user interface, wherein the modification action includes a modification to the time period attribute associated with the second weighted value;
update the selected checklist item based on the modification; and
prompt the participant to respond to the modified checklist item with another update.

5. The computing device of claim 3, wherein the notebook application is further configured to:
identify the update as one of the incomplete status and the abandon status;
detect the second weighted value as being greater than the first weighted value;
enable the originator to execute a modification action on a modification pane of the user interface, wherein the modification action includes a modification to the subject matter attribute associated with the first weighted value;
update the selected checklist item based on the modification; and
prompt the participant to respond to the selected checklist item with another update.

6. The computing device of claim 2, wherein the notebook application is further configured to:
assign a first weighted value to tae historical attribute and assign a second weighted value to the priority attribute; and
compare the first weighted value to the second weighted value.

7. The computing device of claim 6, wherein the notebook application is further configured to:
identify the update as one of the incomplete status and the abandon status;
detect the first weighted value as being greater than the second weighted value;
enable the originator to execute a modification action on a modification pane of the user interface, wherein the modification action includes a modification to the priority attribute associated with the second weighted value;
update the selected checklist item based on the modification; and
prompt the participant to respond to the selected checklist item with another update.

8. The computing device of claim 6, wherein the notebook application is further configured to:
identify the update as one of the incomplete status and the abandon status;
detect the second weighted value as being greater than the first weighted value;
enable the originator to execute a modification action on a modification pane of the user interface, wherein the modification action includes a modification to the historical attribute associated with the first weighted value;
update the selected checklist item based on the modification; and
prompt the participant to respond to the selected checklist item with another update.

9. The computing device of claim 1, wherein the notebook application is further configured to:
in response to enabling the participant to skip the selected checklist item, label the update as having one of the incomplete status and a skipped status.

10. The computing device of claim 9, wherein the notebook application is further configured to:
enable the originator to execute a modification action on a modification pane of the user interface, wherein the modification action includes a modification to the information associated with the selected checklist item based on the incomplete status;
update the selected checklist item based on the modification; and
prompt the participant to respond to the selected checklist item with another update.

11. A method executed by a computing device to provide checklist telemetry, the method comprising:
receiving a checklist from an originator eta process flow document, wherein the checklist includes checklist items;
receiving an update associated with a selected checklist item from a participant, wherein the update includes one of a complete status and an abandon status;
in response to enabling the participant to skip the selected checklist item, labeling the update as having one of an incomplete status and a skipped status:
identifying information from the selected checklist item;
aggregating contents of the checklist, wherein the aggregated contents include the update and the information; and
providing the aggregated contents of the checklist to the originator.

12. The method of claim 11, further comprising:
enabling the participant to provide feedback associated with the selected checklist item, wherein the feedback includes one or more of audio feedback, textual feedback, and graphical feedback; and
enabling the originator to perform one or more actions that include: adding a new checklist item, modifying one of the checklist items, and deleting one of the checklist items.

13. The method of claim 11, further comprising:
performing an analysis on the aggregated contents: and
identifying the selected checklist item as failing to exceed a threshold, wherein the threshold includes one of a timing threshold and an urgency threshold,

14. The method of claim 13, further comprising:
providing an alert to the originator to prompt the originator to modify the information associated with the selected checklist item;
in response to receiving the modification to the information, updating the selected checklist item based on the modification, and
prompting the participant to respond to the selected checklist item with another update.

15. The method of claim 11 further comprising:
performing an analysis on the aggregated contents;
identifying the selected checklist item as exceeding a threshold, wherein the threshold includes one of a timing threshold and an urgency threshold; and
enabling the originator to perform one or more actions that include: modifying a subset of the information associated with the selected checklist item, deleting a subset of the information associated with the selected checklist item, and adding a subset of the information to the selected checklist item.

16. The method of claim 11, further comprising:
performing an analysis on the aggregated contents to determine a historical trend associated with each of the complete status, the abandon status, the skipped status and the incomplete status.

17. A computer-readable storage device with instructions stored thereon for providing checklist telemetry, the instructions comprising:
receiving a checklist from an originator, of a process flow document, wherein the, checklist includes checklist items;
receiving an update associated with a selected checklist item from a participant, wherein the update includes one of a complete status and art abandon status;
in response to enabling the participant, to skip the selected checklist item, labeling the update as having one of an incomplete status and a skipped status;
identifying information from the selected checklist item;
aggregating contents of the checklist, wherein the aggregated contents include the update and the information; and
providing the aggregated contents of the checklist to the originator.

18. The computer-readable storage device of claim 17, wherein the instructions further comprise:
performing an analysis on the aggregated contents;
identifying the selected checklist item as failing to exceed a threshold, wherein the threshold includes one of a timing threshold and an urgency threshold;
providing an alert to the originator to prompt the originator to modify the information associated with the selected checklist item;
in response to receiving the modification to the information, updating the selected checklist item based on the modification; and
prompting the participant to respond to the selected checklist item with another update.

19. The computer-readable storage, device of claim 1, wherein instructions further comprise:
analyzing the information to identify one or more of: a historical attribute associated with a completion of the selected checklist item and indicated by the complete status, a priority attribute associated with the selected checklist item, a subject matter attribute associated with the selected checklist item, and a time period attribute by which the selected checklist item was completed;
assigning a first weighted value to the subject matter attribute and assigning a second, weighted value to the time period attribute; and
comparing the first weighted value to the second weighted value.

20. The computer-readable storage device of claim 19, wherein the instructions further comprise:
identifying the update as one of the incomplete status and the abandon status;
detecting the first weighted value as being greater than the second weighted value;
enabling the originator to modify the time period attribute associated with the second weighted value;
updating the selected checklist item based on the modification; and
prompting the participant to respond to the modified checklist item with another update.
